(19) United States
(12) Patent Application Publication
(10) Pub. No.: US 2024/0039002 A1
(43) Pub. Date: Feb. 1, 2024

(54) LITHIUM BATTERY CELLS WITH REDUCED DENDRITE FORMATION

(71) Applicant: GM GLOBAL TECHNOLOGY OPERATIONS LLC, Detroit, MI (US)

(72) Inventors: Meng JIANG, Rochester Hills, MI (US); Meinan HE, Birmingham, MI (US); Biqiong WANG, Madison Heights, MI (US); Jiazhi HU, Troy, MI (US); Fan XU, Oakland Township, MI (US); Louis G. HECTOR, JR., Shelby Township, MI (US)

(21) Appl. No.: 17/875,577

(22) Filed: Jul. 28, 2022

(51) Int. Cl. H01M 4/66; H01M 10/0525; H01M 10/0585; H01M 4/38; H01M 4/80; H01M 4/36; H01M 4/62

(52) U.S. Cl. CPC H01M 4/668; H01M 10/0525; H01M 10/0585; H01M 4/382; H01M 4/667; H01M 4/661; H01M 4/669; H01M 4/663; H01M 4/808; H01M 4/366; H01M 4/364; H01M 4/623; H01M 4/625; H01M 4/626; H01M 2004/028

(57) ABSTRACT

A battery cell includes a first current collector and a cathode electrode arranged adjacent to the first current collector and including lithium active material. A separator is arranged adjacent to the cathode electrode. The battery cell includes a second current collector. A porous conductive layer is arranged on the second current collector between the second current collector and the separator.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to lithium battery cells with reduced dendrite formation.

Electric vehicles (EVs) such as battery electric vehicles (BEVs), hybrid vehicles, and/or fuel cell vehicles include one or more electric machines and a battery system including one or more battery cells, modules and/or packs. A power control system is used to control power to/from the battery system during charging, propulsion and/or regeneration. If the battery cells include anode electrodes or cathode electrodes that use lithium as the active material, dendrite formation can occur. Dendrites may reduce performance and/or cause short circuits.

### SUMMARY

A battery cell includes a first current collector and a cathode electrode arranged adjacent to the first current collector and including lithium active material. A separator is arranged adjacent to the cathode electrode. The battery cell includes a second current collector. A porous conductive layer is arranged on the second current collector between the second current collector and the separator.

In other features, the porous conductive layer comprises conductive material mixed in a polymer. The polymer comprises polyvinylidene difluoride. The conductive material is selected from a group consisting of stainless-steel particles, copper (Cu), carbon nanofibers, carbon particles, carbon nanotubes including electrodeposited Cu, nickel (Ni), gold (Au) particles, silver (Ag) particles, brass particles, and platinum (Pt) particles. The polymer comprises less than or equal to 30% by weight of the porous conductive layer.

In other features, the conductive material has a nominal size in a predetermined range from 1 micron to 100 microns. The porous conductive layer has a nominal thickness in a predetermined range from 1 micron to 100 microns. The porous conductive layer comprises conductive polymer foam and an adhesive layer attaching the conductive polymer foam to the second current collector.

In other features, electrolyte comprises ionic liquid electrolyte. The porous conductive layer comprises a foam layer including conductive material mixed with conductive polymer and an adhesive layer connecting the foam layer to the second current collector. The foam layer comprises greater than 50% by weight of the foam layer.

A battery cell comprises a first current collector and a cathode electrode arranged adjacent to the first current collector and including lithium active material. A separator is arranged adjacent to the cathode electrode. An anode electrode includes lithium active material. A porous conductive layer is arranged on a first surface of the anode electrode facing the separator. A second current collector is arranged adjacent to the anode electrode.

In other features, the porous conductive layer comprises conductive material and polymer. The polymer comprises polyvinylidene difluoride. The conductive material is selected from a group consisting of stainless-steel particles, copper (Cu), carbon nanofibers, carbon particles, carbon nanotubes including electrodeposited Cu, nickel (Ni), gold (Au) particles, silver (Ag) particles, brass particles, and platinum (Pt) particles. The polymer comprises less than or equal to 30% by weight of the porous conductive layer.

In other features, the conductive material has a nominal size in a predetermined range from 1 micron to 100 microns. The porous conductive layer has a nominal thickness in a predetermined range from 1 micron to 100 microns. The porous conductive layer comprises polymer mixed with conductive material.

In other features, the porous conductive layer comprises conductive polymer foam and an adhesive layer between the conductive polymer foam and the second current collector. Electrolyte comprises ionic liquid electrolyte. The porous conductive layer comprises conductive polymer foam and conductive material. An adhesive layer is arranged between the conductive polymer foam and the second current collector.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 illustrates movement of lithium ions in an anodeless battery cell;

FIG. 2 illustrates the anodeless battery cell of FIG. 1 after a lithium metal layer is formed during an initial charging event;

FIGS. 3 and 4 illustrate the anodeless battery cell of FIG. 2 after dendrites are formed on the lithium metal layer;

FIG. 5 illustrates an example of an anodeless battery cell with a porous conductive layer according to the present disclosure;

FIGS. 6-9 illustrate examples of the porous conductive layers arranged on current collectors according to the present disclosure;

FIG. 10 illustrates an example of a battery cell with a porous conductive layer according to the present disclosure;

FIGS. 11-14 illustrate examples of the porous conductive layers arranged on current collectors according to the present disclosure; and

FIGS. 15-18 are examples of methods for manufacturing the porous conductive layers according to the present disclosure.

In the drawings, reference numbers may be reused to identify similar and/or identical elements.

### DETAILED DESCRIPTION

The present disclosure relates to battery cells with an electrically conductive framework provided by a porous conductive layer that mitigates lithium (Li) dendrite formation in either lithium metal or anodeless battery cells.

In some examples, the porous conductive layer includes a mixture of conductive materials such as metal particles and/or polymer, a mixture of conductive polymer and conductive materials, and/or conductive polymer foam including cell cores. The conductive materials are disordered in that they are located in random locations within the polymer or polymer foam. The porous conductive layer can be made using a slurry coating or a polymer foaming process that creates foam cell cores. The porous conductive layer provides pores or foam cell cores for lithium ions to deposit during charging. The disordered locations of lithium ions in the pores reduce the formation of dendrites that may cause short circuits.

A battery cell according to the present disclosure includes a plurality of cathodes, a plurality of separators, a plurality of anodes (for battery cells with anodes), and a plurality of current collectors. In anodeless battery cells, a porous conductive layer is arranged on the current collectors facing the separator to emulate the anodes. For battery cells with anodes, the porous conductive layer is arranged on the anode layer facing the separator. In some examples, the porous conductive layer is made using an electrode casting method (slurry including conductive metal particles, polymer and solvent applied to the current collectors). In other examples, the porous conductive layer is made using polymer foam and conductive material.

In other examples, the porous conductive layer is made using a polymer foaming process with a conductive polymer. In some examples, an ionic liquid is used in combination with the conductive polymer to improve compatibility and prevent unwanted reactions and/or dissolving of the conductive polymer in electrolyte.

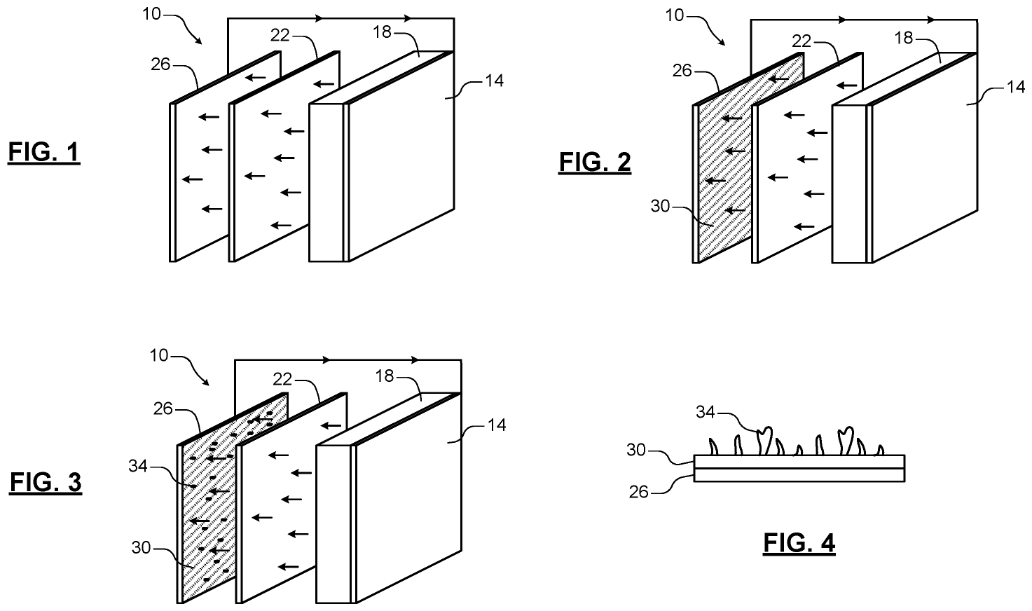

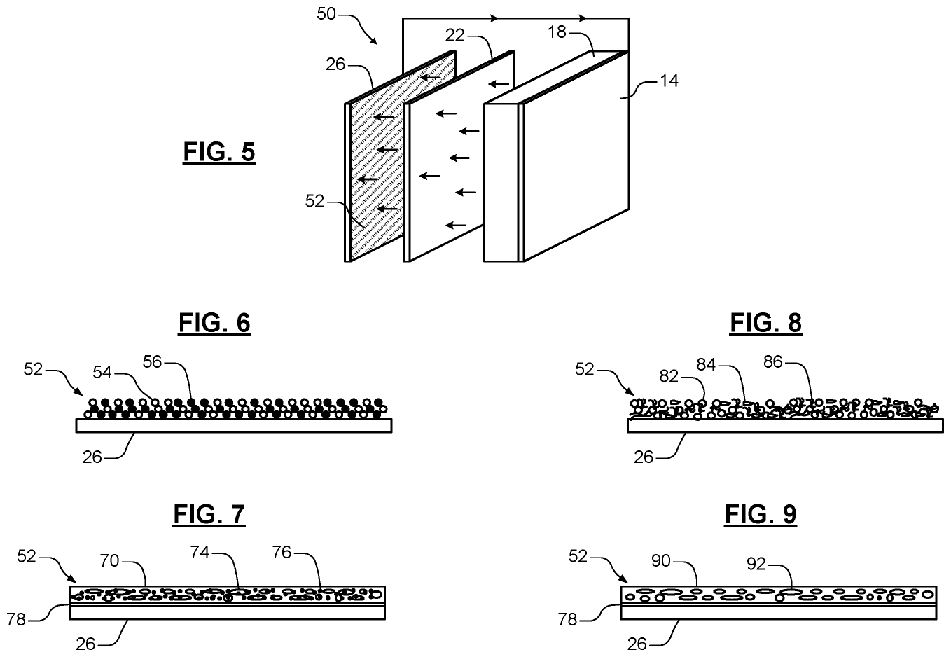

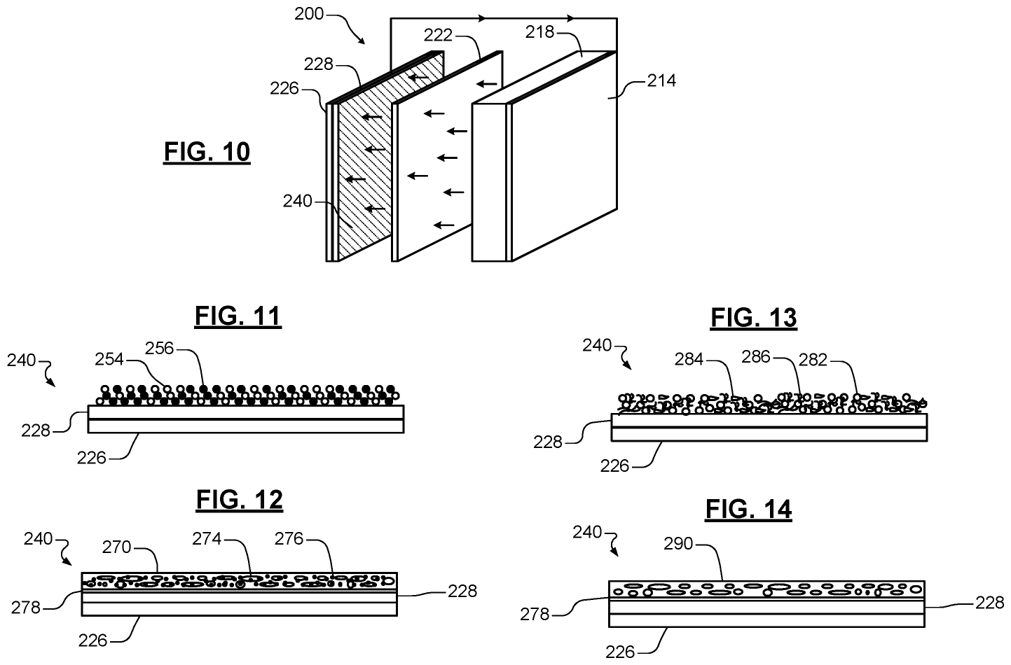

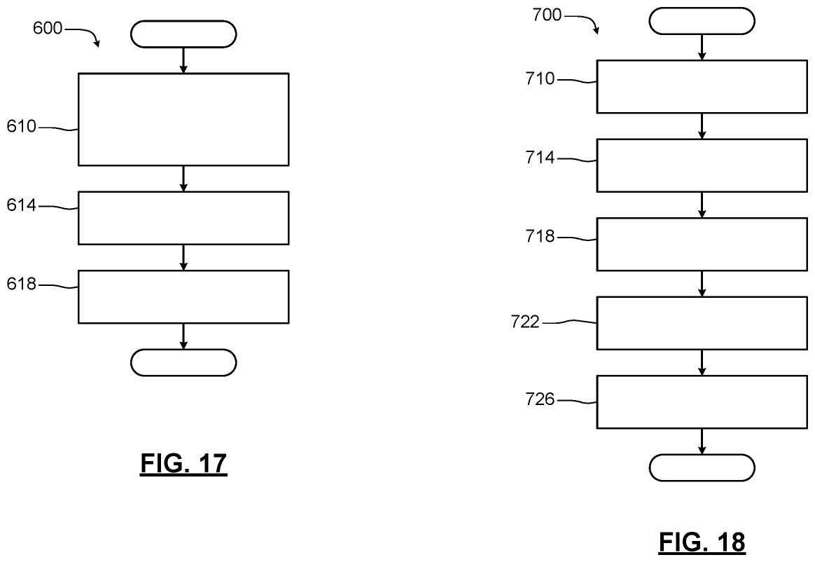

In the description below, FIGS. 1 to 4 show dendrite formation for anodeless battery cells without a porous conductive layer. FIGS. 5-9 illustrate examples of anodeless battery cells with the porous conductive layer. FIGS. 10-14 illustrate examples of battery cells including anodes including active material such as lithium metal and the porous conductive layer. FIGS. 15-18 illustrate methods for manufacturing a porous conductive layer for anodeless battery cells and battery cells with anodes.

Referring now to FIGS. 1 to 4, movement of lithium ions in an anodeless battery cell 10 that does not include a porous conductive layer is shown. In FIG. 1, the anodeless battery cell 10 includes a current collector 14, a cathode electrode 18, a separator 22, and a current collector 26. During charging, lithium ions (arrows) travel from the cathode electrode 18 through the separator 22 to a facing surface of the current collector 26.

In FIG. 2, during initial charging of the anodeless battery cell 10 of FIG. 1, the lithium ions form a lithium metal layer 30 on the surface of the current collector 26. In FIGS. 3 and 4, after additional charging and discharging cycles of the battery cell, dendrites 34 can form on the lithium metal layer 30. The dendrites 34 can reduce performance of the anodeless battery cell 10 and/or cause short circuits.

Referring now to FIGS. 5-9, an example of an anodeless battery cell with a porous conductive layer is shown. In FIG. 5, the anodeless battery cell 50 includes a current collector 14, a cathode electrode 18, a separator 22, and a current collector 26. In some examples, the current collector 14 is made of copper (Cu) foil and the current collector 26 is made of aluminum (Al) foil. The arrows depict movement of lithium ions.

The separator 22 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of PE and PP, or multi-layered structured porous films of PE and/or PP. Commercially available polyolefin porous membranes 26 include CELGARD® 2500 (a monolayer polypropylene separator) and CELGARD® 2320 (a trilayer polypropylene/polyethylene/polypropylene separator) available from Celgard LLC.

the separator 22 may further include one or more of a ceramic coating layer and a heat-resistant material coating. The ceramic coating layer and/or the heat-resistant material coating may be disposed on one or more sides of the separator 22. The material forming the ceramic layer may be selected from the group consisting of: alumina (Al₂O₃), silica (SiO₂), and combinations thereof. The heat-resistant material may be selected from the group consisting of: Nomex, Aramid, and combinations thereof.

When the separator 22 is a microporous polymeric separator, it may be a single layer or a multi-layer laminate, which may be fabricated from either a dry or wet process. For example, in certain instances, a single layer of the polyolefin may form the entire separator 22. In other aspects, the separator 22 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 22. The separator 22 may also comprise other polymers in addition to the polyolefin such as, but not limited to, polyethylene terephthalate (PET), polyvinylidene fluoride (PVDF), a polyamide, polyimide, poly(amide-imide) copolymer, polyetherimide, and/or cellulose, or any other material suitable for creating the required porous structure. The polyolefin layer, and any other optional polymer layers, may further be included in the separator 22 as a fibrous layer to help provide the separator 22 with appropriate structural and porosity characteristics. In certain aspects, the separator 22 may also be mixed with a ceramic material or its surface may be coated in a ceramic material. For example, a ceramic coating may include alumina (Al₂O₃), silicon dioxide (SiO₂), titania (TiO₂) or combinations thereof. Various conventionally available polymers and commercial products for forming the separator 22 are contemplated, as well as the many manufacturing methods that may be employed to produce such a microporous polymer separator 22.

The anodeless battery cell 50 is anodeless since it does not initially include an anode layer including active material such as lithium. A porous conductive layer 52 is arranged on a surface of the current collector 26 facing the separator 22. The porous conductive layer 52 is initially free of active material such as lithium. After charging, the lithium ions travel from the cathode and randomly deposit in pores of the porous conductive layer 52 as shown by arrows. As a result, dendrite formation is reduced.

In FIGS. 6 to 9, various examples of the porous conductive layer 52 are shown. In FIG. 6, the porous conductive layer 52 is shown to include polymer 54 and conductive material 56 randomly arranged in the polymer 54. In some examples, the polymer 54 is nonconductive and is selected from a group consisting of polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, lithium alginate, and combinations thereof.

The porous conductive layer 52 is arranged on the current collector 26 facing the separator 22. In some examples, the porous conductive layer 52 is applied to or cast on the current collector 26 in the form of a slurry including the polymer 54, the conductive material 56 and a solvent. In some examples, the solvent may be fully or partially removed by heating the current collector and the porous conductive layer 52. In some examples, the polymer comprises <=≤30% by weight of the solid mixture. In some examples, the polymer comprises polyvinylidene difluoride (PVDF), although other polymers can be used.

In some examples, the conductive material in the porous conductive layer 52 comprise metal particles. The conductive material in the porous conductive layer 52 does not initially include active material such as lithium. In some examples, the metal particles are selected from a group consisting of stainless-steel particles, copper (Cu), carbon nanofibers, carbon particles, carbon nanotubes including electrodeposited Cu, nickel (Ni), gold (Au) particles, silver (Ag) particles, brass particles, and platinum (Pt) particles. In some examples, the particles have a nominal size in a predetermined range from 1 micron to 100 microns. In some examples, the porous conductive layer has a nominal thickness in a predetermined range from 1 micron to 100 microns. After charging, the lithium ions travel from the cathode and randomly deposit in pores of the porous conductive layer 52. As a result, dendrite formation is reduced.

In FIG. 7, the porous conductive layer 52 is shown to include polymer foam layer 70 including random pockets or voids 74 and conductive material 76 randomly arranged in the polymer foam layer 70. In some examples, the conductive material 76 is mixed with a polymer and a foaming process is used to transform the polymer and the conductive material 76 into polymer foam. In some examples, the polymer comprises greater than 50% by weight of the solid mixture. In some examples, the porous conductive layer 52 is formed separately from the current collector 26 and an adhesive layer 78 is used to attach the porous conductive layer 52 to the current collector 26. After charging, the lithium ions travel from the cathode and randomly deposit on the conductive material 76 in pores of the porous conductive layer 52. As a result, dendrite formation is reduced.

In FIGS. 8 and 9, conductive polymer can be used in the slurry and foaming processes. In FIG. 8, the porous conductive layer 52 is shown to include a conducting polymer 82, conductive material 84 and solvent 86 arranged on the current collector 26. In some examples, the conducting polymer comprises 30% by weight of the solid mixture. In some examples, the porous conductive layer 52 is applied to the current collector 26 as a slurry. In some examples, the solvent may be fully or partially removed by heating the current collector 26 and the porous conductive layer 52. After charging, the lithium ions travel from the cathode and randomly deposit on the conductive material 84 in the porous conductive layer 52. As a result, dendrite formation is reduced.

In FIG. 9, the porous conductive layer 52 is shown to include a conductive polymer foam layer 90 arranged on the current collector 26. In this example, conductive material is not used. A foaming process is used to convert the conductive polymer into the conductive polymer foam layer 90 including random voids 92. After charging, the lithium ions travel from the cathode and randomly deposit in the conductive polymer foam layer 90.

In some examples, conductive polymer is selected from a group consisting of polypyrrole (PPY), polyaniline (PANI), polythiophene (PT), PSS (poly(3,4-ethylenedioxythiophene)polystyrene sulfonate) (PEDOT), copper(II) phthalocyanine (CuPc) doped PPY formed by using copper(II) phthalocyanine tetrasulfanate salts (CuPcTs) to cross-link PPY PF-COONa (sodium poly(9, 9-bis(3-propanoate) fluorine), and sodium alginate grafted poly(3, 4-propylened ioxythiophene (SA-PProDOT).

In some examples, ionic liquid electrolyte can be used with the conductive polymer for compatibility. In some examples, the ionic liquid electrolyte is selected from a group consisting of cation or anion electrolytes. In some examples, the cation electrolytes are selected from a group consisting of imidazolium, pyrrolidinium, and piperidinium. In some examples, imidazolium is selected from a group consisting of 3-ethyl-1-methyl-1H-imidazol-3-ium, 3-allyl-1-methyl-1H-imidazol-3-ium, and 3-butyl-1-methyl-1H-imidazol-3-ium. In some examples, pyrrolidinium is selected from a group consisting of 1-butyl-1-methylpyrrolidin-1-ium, 1-methyl-1-propylpyrrolidin-1-ium, 1-2-methoxyethyl)-1-methylpyrrolidin-1-ium, and 1-methyl-1-pentylpyrrolidin-1-ium. In some examples, piperidinium is selected from a group consisting of 1-methyl-1-propylpiperidin-1-ium and 1-butyl-1methylpiperidin-1-ium.

In some examples, the anion electrolytes are selected from a group consisting of bis(fluorosulfonyl)amide and bis((trifluoromethyl)sulfonyl) amide.

Referring now to FIGS. 10-14, an example of a battery cell with a porous conductive layer is shown. In FIG. 10, the battery cell 200 includes a current collector 214, a cathode electrode 218, a separator 222, an anode electrode 228, and a current collector 226. In some examples, the current collector 214 is made of copper (Cu) foil and the current collector 226 is made of aluminum (Al) foil. In some examples, the cathode electrode 218 and the anode electrode 228 include active material such as lithium. A porous conductive layer 240 is arranged on a surface of the anode electrode 228 facing the separator 222. In some examples, the anode electrode 228 comprises lithium metal foil.

In FIG. 11, the porous conductive layer 240 is shown to include polymer 254 and conductive material 256 arranged on the anode electrode 228. In some examples, the porous conductive layer 240 is applied to the anode electrode 228 in the form of a slurry including the polymer 254, the conductive material 256 and solvent. In some examples, the solvent may be fully or partially removed by heating the anode electrode 228 with the porous conductive layer 240.

In FIG. 12, the porous conductive layer 240 is shown to include a polymer foam layer 270 including voids 274 and conductive material 276 arranged on the anode electrode 228. An adhesive layer 278 attaches the porous conductive layer 240 to the current collector 226. In some examples, the adhesive comprises conductive carbon mixed with polymers such as epoxy, polyester, polyimide, and/or acrylate.

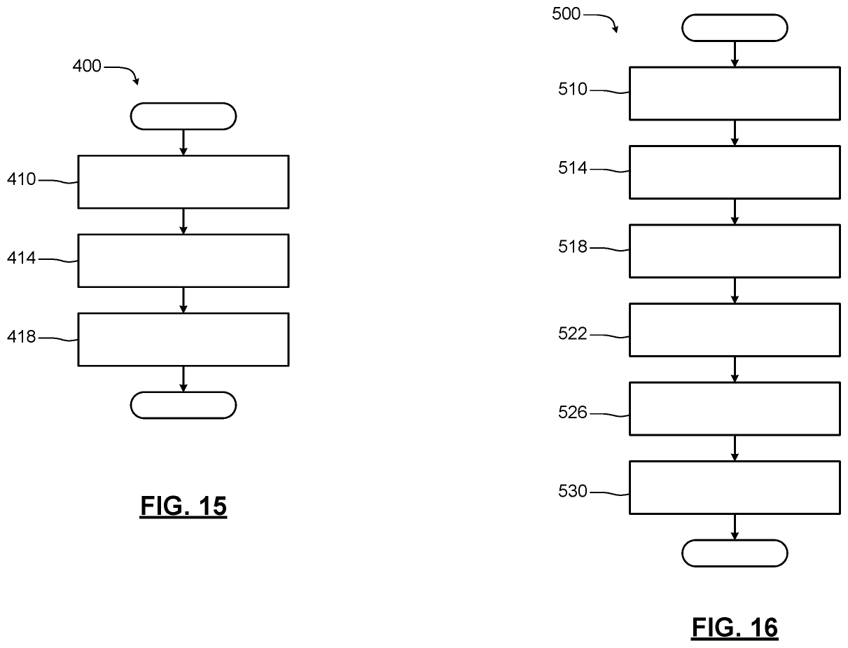

In FIG. 13, the porous conductive layer 240 is shown to include a conducting polymer 282, conductive material 284 and solvent 286 arranged on the anode electrode 228. The porous conductive layer 240 is applied to the current collector 226 in the form of a slurry. In some examples, the solvent is removed by heating the anode electrode 228 with the porous conductive layer 240.

In FIG. 14, the porous conductive layer 240 is shown to include conductive polymer foam layer 290 arranged on the anode electrode 228.

Referring now to FIGS. 15-18, examples of methods for manufacturing a battery cell with the porous conductive layer are shown. In FIG. 15, a method 400 for manufacturing battery cells with the porous conductive layer in FIGS. 6 and 11 is shown. At 410, a slurry mixture is prepared. The slurry mixture includes solvent, polymer, and conductive material that are mixed. At 414, the slurry mixture is applied to a surface of a current collector (FIG. 6) or an anode electrode (e.g., lithium metal) (FIG. 11). At 418, battery cells are assembled using the current collector with the porous conductive layer. In other words, one or more current collectors with the porous conductive layers are combined with one or more cathode electrodes, current collectors, anodes (FIG. 11), and separators of a battery cell.

In FIG. 16, a method 500 for manufacturing a battery cell with the porous conductive layer in FIGS. 7 and 12 is shown. At 510, conductive material is mixed with the polymer. At 514 and 518, a blowing agent is added to the mixture and cores_{[LHJ1]} are formed.

At 522, melt viscosity is increased and/or surfactant is added to form a stable foam layer. At 526, the foam layer (corresponding to the porous conductive layer) is attached to a current collector or anode electrode using an adhesive layer. At 530, battery cells are assembled using the current collector with the porous conductive layer. In other words, one or more current collectors with the porous conductive layers are combined with one or more cathode electrodes, current collectors, anodes (FIG. 12), and separators to form a battery cell.

In some examples, the blowing agent for the foaming process is selected from a group consisting of water, air, nitrogen, carbon dioxide, pentane, hexane, dichloroethane, freon and/or combinations thereof. In some examples, the solvent is an organic solvent. In some examples, the solvent is selected from a group consisting of acetone, NMP, ethanol, methanol, isopropanol, acetonitrile and/or combinations thereof.

In FIG. 17, a method 600 for manufacturing battery cells with the porous conductive layer in FIGS. 8 and 13 is shown. At 610, a slurry mixture is prepared. The slurry mixture includes solvent, conductive polymer, and conductive material that are mixed. At 614, the slurry mixture is applied to a surface of a current collector (FIG. 8) or an anode electrode (FIG. 13). At 618, battery cells are assembled using the current collector with the porous conductive layer. In other words, one or more current collectors with the porous conductive layers are combined with one or more cathode electrodes, current collectors, anodes (FIG. 13), and separators of a battery cell.

In FIG. 18, a method 700 for manufacturing a battery cell with the porous conductive layer in FIGS. 8 and 13 is shown. At 710, conductive additives are mixed with polymer. At 714, a blowing agent is added to the mixture. At 718, cell cores are formed. At 722, viscosity is increased and/or surfactant is added to form a stable foam layer. At 726, the foam layer is attached to a current collector or anode electrode using an adhesive layer. At 730, battery cells are assembled using the current collector with the porous conductive layer. In other words, one or more current collectors with the porous conductive layers are combined with one or more cathode electrodes, current collectors and separators to form a battery cell.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery cell comprising:
a first current collector;
a cathode electrode arranged adjacent to the first current collector and including lithium active material;
a separator arranged adjacent to the cathode electrode;
a second current collector; and
a porous conductive layer arranged on the second current collector between the second current collector and the separator.

2. The battery cell of claim 1, wherein the porous conductive layer comprises conductive material mixed in a polymer.

3. The battery cell of claim 2, wherein the polymer comprises polyvinylidene difluoride.

4. The battery cell of claim 2, wherein the conductive material is selected from a group consisting of stainless-steel particles, copper (Cu), carbon nanofibers, carbon particles, carbon nanotubes including electrodeposited Cu, nickel (Ni), gold (Au) particles, silver (Ag) particles, brass particles, and platinum (Pt) particles.

5. The battery cell of claim 2, wherein the polymer comprises less than or equal to 30% by weight of the porous conductive layer.

6. The battery cell of claim 2, wherein:
the conductive material has a nominal size in a predetermined range from 1 micron to 100 microns; and
the porous conductive layer has a nominal thickness in a predetermined range from 1 micron to 100 microns.

7. The battery cell of claim 1, wherein the porous conductive layer comprises:
conductive polymer foam; and
an adhesive layer attaching the conductive polymer foam to the second current collector.

8. The battery cell of claim 7, further comprising electrolyte, wherein the electrolyte comprises ionic liquid electrolyte.

9. The battery cell of claim 1, wherein the porous conductive layer comprises:
a foam layer including conductive material mixed with conductive polymer; and
an adhesive layer connecting the foam layer to the second current collector.

10. The battery cell of claim 9, wherein the foam layer comprises greater than 50% by weight of the foam layer.

11. A battery cell comprising:
a first current collector;
a cathode electrode arranged adjacent to the first current collector and including lithium active material;
a separator arranged adjacent to the cathode electrode;
an anode electrode including lithium active material;
a porous conductive layer arranged on a first surface of the anode electrode facing the separator; and
a second current collector arranged adjacent to the anode electrode.

12. The battery cell of claim 11, wherein the porous conductive layer comprises conductive material and polymer.

13. The battery cell of claim 12, wherein the polymer comprises polyvinylidene difluoride.

14. The battery cell of claim 12, wherein the conductive material is selected from a group consisting of stainless-steel particles, copper (Cu), carbon nanofibers, carbon particles, carbon nanotubes including electrodeposited Cu, nickel (Ni), gold (Au) particles, silver (Ag) particles, brass particles, and platinum (Pt) particles.

15. The battery cell of claim 12, wherein the polymer comprises less than or equal to 30% by weight of the porous conductive layer.

16. The battery cell of claim 12, wherein:
the conductive material has a nominal size in a predetermined range from 1 micron to 100 microns; and
the porous conductive layer has a nominal thickness in a predetermined range from 1 micron to 100 microns.

17. The battery cell of claim 11, wherein the porous conductive layer comprises polymer mixed with conductive material.

18. The battery cell of claim 11, wherein the porous conductive layer comprises:
conductive polymer foam; and
an adhesive layer between the conductive polymer foam and the second current collector.

19. The battery cell of claim 18, further comprising electrolyte, wherein the electrolyte comprises ionic liquid electrolyte.

20. The battery cell of claim 11, wherein the porous conductive layer comprises:
conductive polymer foam and conductive material; and
an adhesive layer between the conductive polymer foam and the second current collector.
